(19) United States
(12) Patent Application Publication
(10) Pub. No.: US 2010/0025551 A1
(43) Pub. Date: Feb. 4, 2010

(54) Membranous organizer

(75) Inventor: Chi Hang Mak, Scarborough (CA)

Correspondence Address: SIMPSON & SIMPSON, PLLC, 5555 MAIN STREET, WILLIAMSVILLE, NY, 14221-5406, US

(73) Assignee: Umbra LLC, Buffalo, NY (US)

(21) Appl. No.: 12/221,317

(22) Filed: Aug. 1, 2008

(51) Int. Cl. F16M 13/00

(52) U.S. Cl. 248/158; 248/127

(57) ABSTRACT

An item organizer including a base having a first membrane, the first membrane being substantially planar, an item holder having a second membrane, the second membrane being substantially planar and having at least one aperture, and at least one support arm extending between the base and the item holder, wherein the first membrane and the second membrane are substantially parallel, and the at least one support arm is operatively arranged to suspend the holder over the base.

### FIELD OF THE INVENTION

The invention broadly relates to organizers used for holding and organizing items on horizontal surfaces, such as, desktops, countertops, vanity tables, etc.

### BACKGROUND OF THE INVENTION

Organizers used for holding and organizing items on horizontal surfaces, such as desktops and countertops, are well known. For example, desktop organizers are used for holding and organizing items such as pens, pencils, scissors, markers, etc. Organizers of this type are also commonly used next to bathroom sinks for holding and organizing items such as toothbrushes, combs, and toothpaste tubes.

Generally, an organizer of this type comprises a base and a plurality of long receptacles extending upwardly from the base, each of which terminates at an aperture. Each receptacle is operatively arranged to receive an item, separate the item from items disposed within other receptacles, and present the item in a substantially vertical position to a user. These prior organizers are usually made from a smooth, rigid material, such as, molded plastic, ceramic, or wood, as a receptacle formed from such material provides quick and easy insertions and extractions of an item.

One problem with prior organizers of this type is that the receptacles do not securely hold the items inserted therein. Since the receptacles, including their respective apertures, are rigid and smooth, the items are loosely held therein, unless, of course, an item too large for a receptacle is wedged into it, which would damage the receptacle and/or item. The only reason an item held within a receptacle stays within the receptacle, is the vertical arrangement of the receptacle in combination with gravity. Thus, if an organizer holding items is tipped over, the items will quickly spill out. Moreover, while spilling a plurality of pens and pencils onto or off a desktop is a nuisance, spilling toothbrushes onto a bathroom floor is unhygienic and rather repugnant. It should be noted that prior organizers of this type are also ill-suited for holding toothbrushes, because water and residue derived from a used toothbrush tends to become trapped and collects at the bottom of the receptacle, often unbeknownst to the user.

Another problem with prior organizers of this type is that the receptacles are limited with respect to the size and shape of items they can receive, due to the fixed dimensions of the receptacles provided by the rigid material from which they are made. Since these organizers are primarily used for holding long, slender items, such as pencils, pens, and toothbrushes, their receptacles are generally long and slender. Not only is this receptacle design limiting with respect to the items it can receive, but small items, such as paperclips and tacks, are difficult to retrieve from the bottom of the receptacle. When a small item happens to falls into a long, slender receptacle, the user is forced to either remove the other items held in the organizer and then tip it over to retrieve the small item, or simply leave it at the bottom of the receptacle to avoid such nuisance.

Another problem with prior organizers of this type is that the bottom of a receptacle, due to its rigid material, tends to dull the tips of sharp items held therein, such as, pencils, scissors, and utility knives used for crafts and hobbies.

Thus, there is a long-felt need for an organizer that securely holds items. There is also a long-felt need for an organizer that does not trap and collect water or small items. Additionally, there is a long-felt need for an organizer that can receive and accommodate items of various shapes and sizes. Finally, there is a long-felt need for an organizer that does not dull the tips of sharp items held therein.

### BRIEF SUMMARY OF THE INVENTION

Broadly, the present invention is an item organizer comprising a first substantially planar membrane, a second substantially planar membrane comprising at least one aperture, and a support arm operatively arranged to suspend the second membrane above the first membrane.

More particularly, the invention is an item organizer comprising: a base comprising a first membrane, the first membrane being substantially planar; an item holder comprising a second membrane, the second membrane being substantially planar and comprising at least one aperture; and, at least one support arm extending between the base and the item holder, wherein the first membrane and the second membrane are substantially parallel, and the at least one support arm is operatively arranged to suspend the item holder over the base.

In one embodiment, the item organizer comprises: a substantially closed loop of wire arranged as a first ring, a second ring, and at least one, but preferably two, linear extensions extending between the first ring and the second ring; a first membrane stretched over the first ring; a second membrane stretched over the second ring, the second membrane comprising at least one aperture, and the at least one, but preferably two, linear extensions are operatively arranged to suspend the second ring and second membrane over the first ring and first membrane.

It is a general object of the present invention to provide an organizer that securely holds items.

It is another general object of the present invention to provide an organizer that does not trap and collect water or small items.

It is yet another object of the present invention to provide an organizer that can receive and accommodate items of various shapes and sizes.

It is a further object of the present invention to provide an organizer that does not dull the tips of sharp items held therein.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of the present invention item organizer holding a plurality of items;

FIG. 2 is a perspective view of the item organizer alone;

FIG. 3 is an exploded perspective view of the item organizer;

FIG. 4 is a top plan view of the item organizer;

FIG. 5 is a bottom plan view of the item organizer;

FIG. 6 is a front elevational view of the item organizer;

FIG. 7 is a back elevational view of the item organizer;

FIG. 8 is a left side elevational view of the item organizer;

FIG. 9 is a right side elevational view of the item organizer;

FIG. 10A is a perspective view of a first step for securing an item in a tapered aperture of the item organizer;

FIG. 10B is a perspective view of a second step for securing the item in the tapered aperture; and,

FIG. 10C is a perspective view of a third step for securing the item in the tapered aperture.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “membrane” refers to a thin soft pliable sheet or layer, and the terms “elastomer” and “elastomeric” refer to a polymer with the property of elasticity. Although any methods, devices or materials similar or equivalent to those described herein can be used in the practice or testing of the invention, the preferred methods, devices, and materials are now described.

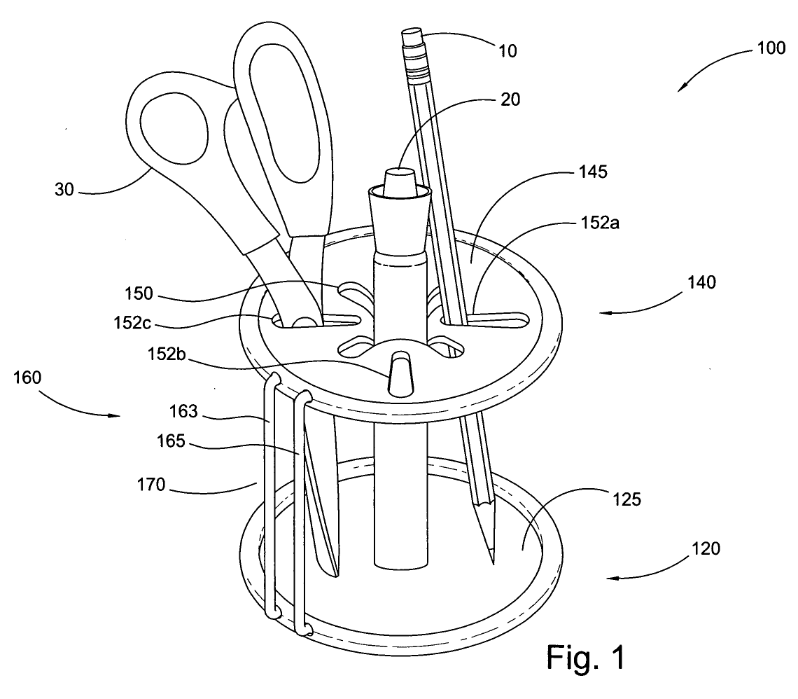

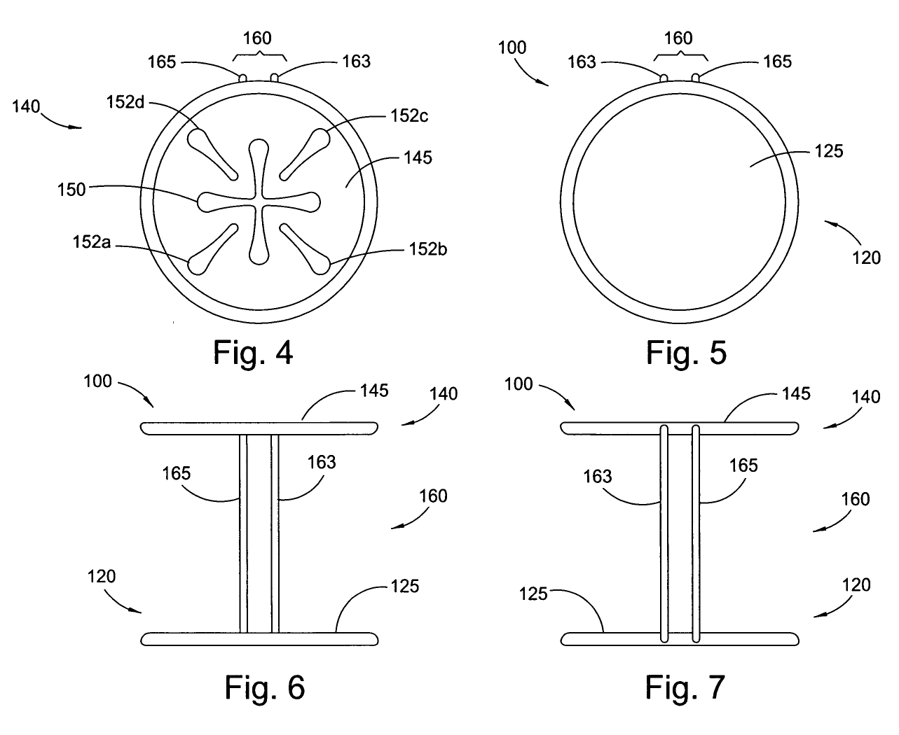

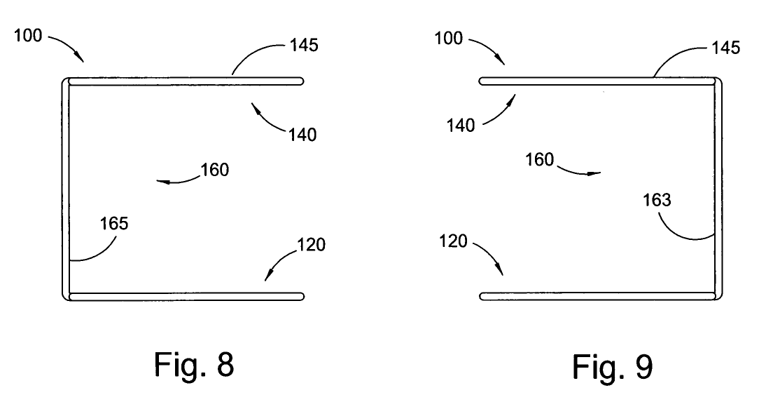

The following description is best understood in view of FIGS. 1-10C. FIG. 1 is a perspective view of item organizer 100, hereinafter referred to as organizer 100. In this figure, organizer 1 is shown holding a plurality of items, i.e., pencil 10, marker 20, and scissors 30. Organizer 100 broadly comprises base 120, item holder 140, and support arm 160, which is arranged to suspend item holder 140 over base 120. Base 120 generally comprises a substantially planar first membrane 125. Item holder 140 generally comprises a substantially planar second membrane 145, which includes at least one aperture, as described in further detail infra. First membrane 125 and second membrane 145 may comprise and suitable material that is elastic. Preferably, however, each comprises an elastomer, such as silicone.

Preferably, first membrane 125 and second membrane are arranged in substantially parallel planes, and second membrane 145 is suspended directly above first membrane 125 by support arm 160. Additionally, support arm 160 is preferably arranged substantially perpendicular with respect to first membrane 125 and second membrane 145.

In general, a substantially planar membrane of flexible material cannot maintain its planarity without assistance from some form of infrastructure, especially if one dimension of the plane in which it is disposed is not collinear with the directional force of gravity. Accordingly, first membrane 125 and second membrane 145 should each be provided with such infrastructure, which may be any suitable means for maintaining planarity, such as, an internal or external frame. The frame may be of any type, for example, a molded plastic frame.

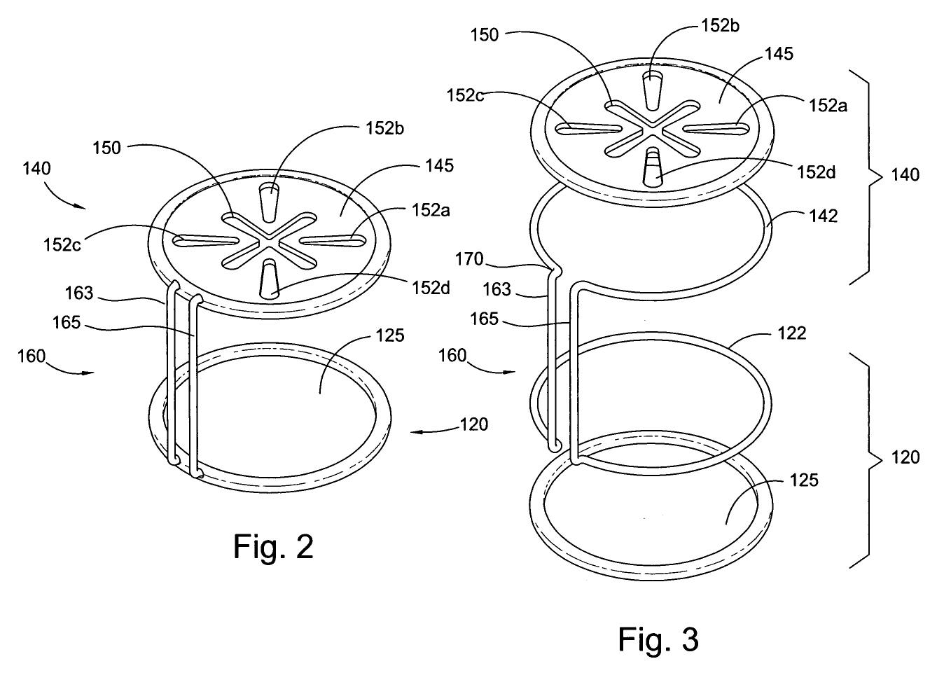

In the embodiment shown in the figures, such infrastructure comprises a substantially closed loop of wire 170, substantially rigid, (see FIG. 2) arranged as first ring 122, second ring 142, and two linear extensions, 163 and 165, which extend between first ring 122 and second ring 142. In this embodiment, first membrane 125 is stretched over first ring 122, and second membrane 145 is stretched over second ring 145. Once stretched over their respective rings, first membrane 125 and second membrane 145 can be secured in place by any suitable means known in the art. For example, as shown in the figures, each membrane may be wrapped around its respective ring such that it completely encases the ring, and then bonded to the ring or itself by a suitable means, for example, heat sealing or adhesives. However, it is contemplated, and is within the scope and spirit of the invention, that wire 170 may be arranged as first ring 122, second ring 142, and a single linear extension extending therebetween. While the figures show first ring 122, first membrane 125, second ring 142, and second membrane 145 arranged as circles, it is contemplated that these elements may arranged in a variety of shapes, such as, triangles, hexagons, ellipses, etc., by simply bending wire 170 into those shapes.

In the embodiment shown in the figures, base 120 further comprises first ring 122, and item holder 140 further comprises second ring 140. Moreover, support arm 160 comprises linear extensions 163 and 165. Since first ring 122, second ring 142, and linear extensions 163 and 165 are all formed from wire 170, first ring 122 and second ring 142 can be bent toward each other, preferably such that first membrane 125 and second membrane 145 are in substantially parallel planes. With this arrangement, linear extensions 163 and 165, serving as support arm 160, are operatively arranged to suspend second ring 142 and second membrane 145 over first ring 122 and first membrane 125, when base 120 is resting on a substantially horizontal surface.

As stated supra, second membrane 145 comprises at least one aperture, which is arranged to receive and hold an item therein, but may comprise a plurality of apertures, which may be of various shapes and sizes. The at least one aperture is operatively arranged to securely hold an item inserted therethrough by means of a compression fit, wherein the aperture is arranged to deform when an item is inserted therethrough, and the edge of the membrane that defines the aperture is pressed against the item, thereby generating a frictional engagement between the membrane and the item. Thus, the apertures are preferably configured to have at least one dimension, e.g., width or length, which is narrower than the items the apertures are intended to receive.

In the embodiment shown in the figures, second membrane comprises a plurality of apertures, namely, cruciform aperture 150 and tapered apertures 152a-d. As shown in the figures, the arrangement of these apertures is such that cruciform aperture is arranged substantially in the center of second membrane 145, and tapered apertures 152a-d are arranged radially with respect to such center.

Cruciform aperture 150 is versatile with respect to the sizes and shapes of items it can receive and hold. As it is in the form of a cross, it comprises four narrow gaps, each of which can receive and hold a thin item, such as, a pencil. However, each pair of opposing gaps forms one longer narrow gap, which can receive and hold a thin, wide item, such as a ruler. In the alternative, the entire cross can deform to receive and hold a large, thick item, such as marker 20 shown in FIG. 1. It is contemplated, and within the scope and spirit of the invention, that second membrane 145 may comprise a plurality of cruciform apertures.

A single tapered aperture, such as each of apertures 152a-d, is operatively arranged to receive and hold items of various widths. For example, a wide item may fit in the wide portion of a tapered aperture, but not in the narrow, tapered portion. Alternatively, the wide portion may be too large to provide a compression fit for a very narrow item, in which case the narrow item can be secured in the tapered portion.

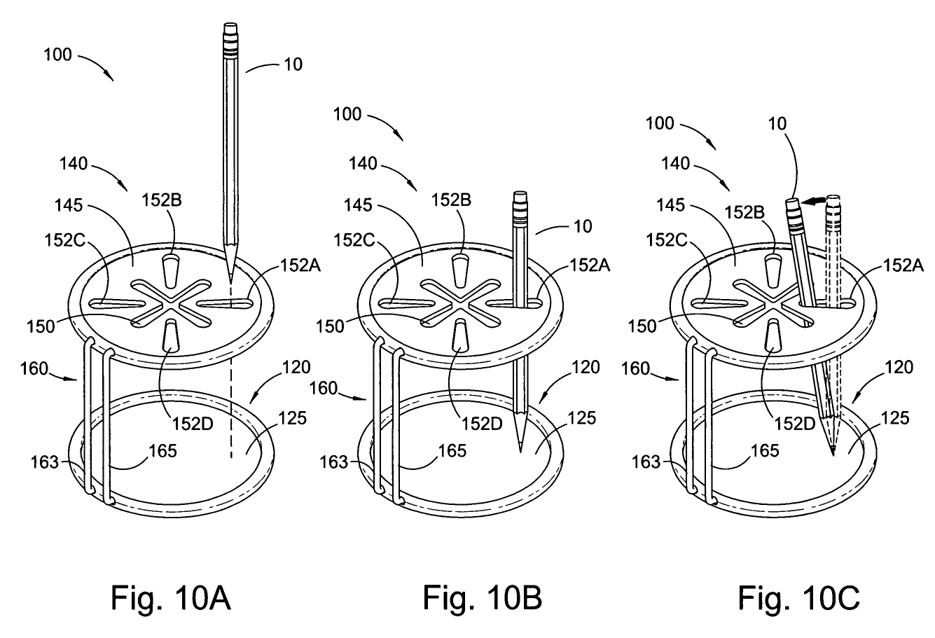

FIGS. 10A-10C show a method by which a user can determine the optimal position of an item he wishes to secure within tapered aperture 152a. FIG. 10A shows a first step in the method, wherein the tip of pencil 10 is poised above the wide portion of tapered aperture 152a. FIG. 10B shows a second step in the method, wherein pencil 10 is inserted through the wide portion of tapered aperture 152a, with its tip pressed against first membrane 125. Since first membrane 125 comprises an elastomeric material, such as, silicone, its surface deforms in response to the tip of pencil 10. Thus, an elastomeric material should be chosen for first membrane 125 that deforms, but does not tear, in response to a sharp tip. Were first membrane 125 to comprise a rigid material, its surface would not deform, and would likely dull the tip of pencil 10. FIG. 10C shows a third step in the method, wherein pencil 10 is pivoting on its tip, as the deformed surface of first membrane 125 provides a frictional engagement with, and holds steady, the tip. In this figure, pencil 10 is being guided from the wide portion into the narrow, tapered portion of tapered aperture 152a, in order to secure it in organizer 100. This arrangement of opposing membranes and apertures can safely secure a plurality of items even when the organizer is held upside-down.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. An item organizer comprising:
a base comprising a first membrane, the first membrane being substantially planar;
an item holder comprising a second membrane, the second membrane being substantially planar and comprising at least one aperture; and,
at least one support arm extending between the base and the item holder, wherein the first membrane and the second membrane are substantially parallel, and the at least one support arm is operatively arranged to suspend the item holder over the base.

2. The item organizer recited in claim 1 wherein the at least one support arm is arranged substantially perpendicular to the base and the item holder.

3. The item organizer recited in claim 1 wherein the base comprises a first ring and the first membrane is stretched over the first ring.

4. The item organizer recited in claim 1 wherein the base comprises a second ring and the second membrane is stretched over the second ring.

5. The item organizer recited in claim 1 wherein the at least one aperture is cruciform.

6. The item organizer recited in claim 1 wherein the at least one aperture is tapered.

7. The item organizer recited in claim 1 wherein the second membrane comprises a plurality of apertures having at least one cruciform aperture and at least one tapered aperture.

8. The item organizer recited in Claim xx wherein the second membrane comprises a center, the at least one cruciform aperture is arranged at the center, and the at least one tapered aperture is arranged radially with respect to the center.

9. The item organizer recited in claim 1 wherein the first membrane and/or the second membrane comprise an elastomer.

10. The item organizer recited in claim 9 wherein the elastomer comprises silicone.

11. An item organizer comprising:
a frame comprising a substantially closed loop of wire arranged as a first ring, a second, and at least one linear extension extending between the first ring and the second ring;
a first membrane stretched over the first ring;
a second membrane stretched over the second ring, the second membrane comprising at least one aperture, and the at least one linear extension is operatively arranged to suspend the second membrane over the first membrane.

12. The item organizer recited in claim 11 wherein the substantially closed loop of wire is arranged as a first ring, a second, and two linear extensions extending between the first ring and the second ring.

13. The item organizer recited in claim 11 wherein the at least one aperture is cruciform.

14. The item organizer recited in claim 11 wherein the at least one aperture is tapered.

15. The item organizer recited in claim 11 wherein the second membrane comprises a plurality of apertures having at least one cruciform aperture and at least one tapered aperture.

16. The item organizer recited in claim 11 wherein the first membrane and/or the second membrane comprise an elastomer.

17. The item organizer recited in claim 16 wherein the elastomer comprises silicone.

18. An item organizer comprising:
a first substantially planar membrane;
a second substantially planar membrane comprising at least one aperture; and,
a support arm operatively arranged to suspend the second membrane above the first membrane.

19. The item organizer recited in claim 18 wherein the first membrane and/or the second membrane comprise an elastomer.

20. The item organizer recited in claim 18 wherein the second membrane comprises a plurality of apertures, at least one of which is cruciform, and at least one of which is tapered.
